(19) United States
(12) Patent Application Publication
(10) Pub. No.: US 2007/0146284 A1
(43) Pub. Date: Jun. 28, 2007

(54) INTERFACE IDLE TERMINAL PROCESSING METHOD AND INTERFACE DEVICE EMPLOYING SAME

(76) Inventor: Atsushi KOTA, Kawasaki-shi (JP)

Correspondence Address: Norman P. Soloway;HAYES SOLOWAY P.C., Suite 140, 3450 E. Sunrise Drive, Tucson, AZ, 85718, US

(21) Appl. No.: 11/548,081

(22) Filed: Oct. 10, 2006

(30) Foreign Application Priority Data
Oct. 18, 2005 (JP) 2005-303396

(51) Int. Cl. G09G 3/36

(52) U.S. Cl. 345/98

(57) ABSTRACT

An interface device is provided which is capable of eliminating the need for mounting an external resistor and of reducing manufacturing costs for the interface device. An internal resistor and a PMOS (p-channel Metal Oxide semiconductor) switch are serially connected between a non-inverted input terminal of an LVDS (Low Voltage Differential Signaling) receiver of a D channel out of LVDS signal channels. An NMOS (n-channel MOS) switch and an internal resistor are serially connected between an inverted input terminal of the LVDS receiver and a ground (GND). To a gate input terminal of the PMOS switch is connected an terminal for an idle terminal setting input terminal while an inverter is connected to an gate input terminal of the NMOS switch.

### BACKGROUND OF THE INVENTION

1. Field of the Invention

The present invention relates to an interface idle terminal processing method and an interface device employing the same and more particularly to the interface idle terminal processing method which is capable of using electronic circuits on a receiver side without occurrence of unstable states even when a specified differential signal transmission path out of a plurality of differential signal transmission paths is not used and to the interface using the same method.

The present application claims priority of Japanese Patent Application No. 2005-303396 filed on Oct. 18, 2005, which is hereby incorporated by reference.

2. Description of the Related Art

In recent years, in a field of monitors of a computer, as a flat panel display is upsized and is made high-definition, amounts of data to be processed per unit time increase and a demand for high-speed transmission of data are becoming strong. An example of the flat panel display is a liquid crystal display device. The liquid crystal display device generally includes N-pieces (N is an integer of one or more) of source drives mounted in an upper portion of a liquid crystal panel, M-pieces (M is an integer of one or more) of gate drivers mounted in a side portion of the liquid crystal panel, a graphics controller, a timing controller to control each of the above drivers by outputs from the graphics controller, and a power supply to apply voltages to each of the above drivers.

The graphics controller of the liquid crystal display device outputs timing information for displaying such as clocks to be transmitted from computers, control information such as a horizontal sync signal (HSC), vertical sync signal (VSC), and the like, and each information about image data to the timing controller. In the timing controller is embedded a receiver that receives information from the graphics controller through a transmitter from which input image data, start signal, and clock signal to be fed to each driver according to timing information are output.

The source drivers are made up of a plurality of stages being serially connected to one another. Each of the source drivers that receives start signals and clock signals from the timing controller also captures image data at timing when receiving the start and clock signals and then converts the captured image data into data having a voltage value (gray-scale voltage) for every one line of pixels, and further applies, through a drain electrode of each of TFTs (Thin Film Transistors) to be brought into conduction (to be turned ON) by a gate driver, the gray-scale voltage to each of pixel electrodes, which makes up pixels of a liquid crystal panel, on every one line. The gate driver controls sequentially all gate electrodes of TFTs existing on every one line, in synchronization with a clock signal, according to a frame start signal and clock signal fed from the graphics controller, so that each of the TFTs is brought into conduction and the above gray-scale voltage from the source driver is applied to each pixel electrode at the time when the TFT becomes conducting.

The conventional display control system is constructed as above. However, a signal transmission method employed in the conventional liquid crystal display device has a problem. That is, in the conventional signal transmission system using a CMOS (Complementary MOS) method or an LVTTL (Low Voltage Transistor Transistor Logic) method which is used for interfacing between a graphics controller 110 and a timing controller 112 (see FIG. 13), even though supply power of as low as 2.5V to 3.3V is applied, when graphic display resolution (specification) is of an SVGA (Super Video Graphic Array) level or so, a frequency for an input video signal that can be used is up to 40 MHz. However, if the level of the graphic display resolution is higher than that of the SVGA, such a low frequency as above cannot be used for an input video signal. Moreover, in the conventional signal transmission method, if an image is to be displayed in 256 gray levels by using eight bits for every signal line, in order to display three colors, 24 signal lines (8 bits×3 colors RGB) are required and, in this case, a signal amplitude becomes as large as 2.5V to 3.3V, which produces disadvantages in terms of EMI (Electromagnetic Interference).

To solve these problems, an LVDS (Low Voltage Differential Signaling) transmission method is disclosed (this method has been developed by National Semiconductor Inc. in the U.S.) which has achieved high-speed signal transmission, low power consumption, a small EMI problem by transmitting differential signals with low voltage changes using a small number of signal lines and copper wires. This signal transmission method provides an advantage in that stable operations can be realized, even if there are changes in load conditions, owing to flow of constant currents on transmission lines.

If a level of the graphic display resolution is higher than that of an XVG displaying specification, a frequency of an input video signal that can be used is 65 MHz or more and, therefore, the LVDS transmission method is generally used as a method for interfacing between a graphics controller that feeds input video signals and a timing controller that receives the video signal in a display device. In the LVDS transmission method, a total of five channels including four channels to be assigned for 8-bit data signals to a R (Red) color signal, a G (Green) color signal and a B (Blue) color signal, and a synchronizing signal such as VSC, HSC, and DE (Data Enable) signals and one channel to be assigned to a clock signal (CLK) is used. Specifically, as shown in FIG. 9, an LVDS receiver core embedded in the timing controller is made up of a total of five channels including an A channel, B channel, C channel, and D channel each being assigned for a 8-bit data signal to a corresponding one of a R (Red) color signal, a G (Green) color signal and a B (Blue) color signal, and a synchronizing signal such as a VSC, HSC, and DE signal and of one channel to be used for a clock signal. When an input video signal is eight bits long, all four channels of the A, B, C, and D channels are used, however, if the input video signal is six bits long, though the A, B, and C channels are used, the D channel is not used.

In the LVDS transmission method, 3.5 mA DC (Direct Current) driving-type interfacing is employed in which a terminating resistor is required on a receiver side and an amplitude of an LVDS signal is determined by the terminating resistor on the receiver side and, if the resistance of the terminating resistor on the receiver side is 100 Ω, the amplitude of the LVDS signal is 350 mV. Moreover, a frequency of an input video signal that can be used is up to 135 MHz.

In the LVDS transmission method, when an input terminal is released, a potential of the input terminal becomes unstable and, as a result, an output from the LVDS receiver becomes unstable. To solve this problem, one technological unit is disclosed in Patent Reference 1 (Japanese Patent Application Laid-open No. 2005-033571). The disclosed unit includes an inputting section to receive differential signals, a differential amplifying section to be connected to the inputting section, a grounding section to ground the inputting section when the inputting section is in an open state to stop operations of the differential amplifying section, and an outputting section to monitor to check whether or not operations of the differential amplifying section are stopped and makes the above differential amplifying section output a logical value corresponding to the result from the checking.

Moreover, technology obtained by improving a small amplitude differential signal interface developed based on the LVDS transmission method is disclosed in Patent Reference 2 (Japanese re-publication of PTC international publication for patent application WO2002/047063). In this technology, to solve a problem of a narrow variation tolerance of a central voltage of a differential signal to be used in the above small amplitude differential signal interface, the tolerance is made wider to reduce power consumption, that is, a semiconductor integrated circuit having a differential amplifying stage and an output stage to generate an output signal based on a voltage fed from one output terminal of the differential amplifying stage, a source voltage being higher than a source voltage to be applied to the above output stage is applied to a source voltage terminal of the above differential amplifying stage. Moreover, the output stage of the differential amplifying stage is provided with a standby function means which forcedly makes an output from the differential amplifying stage be held “low” during standby time.

In the LVDS transmission method which can achieve high-speed transmission, low power consumption, or a like, when an input video signal is six bits long and no video signal is input to the D channel, if no idle terminal processing is performed on an input terminal of the D channel, an output signal to be output from the D channel becomes unstable and, as a result, an output signal from the timing controller becomes unstable. This leads to degradation in image quality of a display device controlled by the timing controller.

To solve these technological problems, it is necessary to perform idle terminal processing to make an output from the LVDS receiver become stable by applying a desired voltage to an input terminal of the unused D channel. One example of the idle terminal processing method is to apply a voltage from a power supply unit (Vcc voltage), GND terminal, or a like which was employed in the conventional CMOS interfacing method. However, if this method is employed, since differential signals are used in the LVDS transmission method, if a voltage of Vcc or GND is applied to each of the input terminal RD_P and RD_N of the unused D channel, a difference in voltage becomes 0V and, as a result, the output from the LVDS receiver becomes high or low and unstable due to even a very low noise in the input voltage.

To avoid this unstable state of the output from the D channel receiver, there is a method in which a voltage of Vcc and a voltage of GND, both being different from each other, or a voltage of GND and a voltage of Vcc, both also being different from each other, are applied to each of the input terminal RD_P and RD_N of the unused D channel. However, it is necessary that input signals to the LVDS receiver meet the input specification of DC (Direct Current) characteristics shown in FIGS. 10 and 11. In FIG. 11, “y” represents any one of the A, B, C, and D channels. “RCLK_P” and “Ry_P” represent a voltage of a non-inverted phase signal transmission path of each channel. “RCLK_N” and “Ry_N” represent a voltage of an inverted phase signal transmission path. Difference voltages “RCLK” and “Ry” represent respectively|VID|=|RCLK_P-RCLK_N| and |VID|=|Ry_P-Ry_N| and the voltage “VICM” occurring at time when a difference in correlation is zero represents (Ry_P+Ry_N)/2. One method to satisfy the conditions for inputting specifications described above is to divide a voltage of Vcc by using a resistor mounted outside of the timing controller to generate a desired voltage that can meet the inputting specifications and to apply each of the obtained desired voltages to the input terminal of the D channel.

However, in this method, if a desired voltage that meets the inputting specifications is input to both of the input terminals RD_P and RD_N of the unused D channel, since differential signals are used in the LVDS transmission method, a difference in voltage becomes 0 V and, as a result, the output from the LVDS receiver of the D channel becomes high or low and unstable due to even a very low noise in the input voltage.

It is necessary that an output from the LVDS receiver is clamped to be “high” or “low” by applying a desired voltage that can meet the inputting specifications to each of the input terminals RD_P and RD_N of the unused D channel.

In the conventional idle terminal processing in the LVDS transmission method, as shown in FIG. 12, a terminating resistor 52 is connected to the input terminals RD_P and RD_N and the input terminal RD_P to be connected to a non-inverted phase transmission path serving as a differential signal transmission path making up the unused D channel is connected to a power supply 56 with a voltage of Vcc through a resistor 54 and the input terminal RD_N is connected to a ground (GND) 60 through a resistor 58.

In the above idle terminal processing method, for example, if resistance of the terminating resistor 52 is 100Ω, resistance of the resistor 54 is 475 Ω, resistance of the resistor 58 is 250 Ω, and the voltage of Vcc is 3.3V, a voltage of 1.4V is applied to the input terminal RD_P and a voltage of 1.0V is applied to the input terminal RD_N and, therefore, the above inputting specifications are satisfied and an output from LVDS receiver 14D is clamped to be “high” and becomes stable.

In the above conventional idle terminal processing method, it is possible that the idle terminal processing can be performed on the input terminal of the unused D channel and the unstable state of an output from the LVDS receiver 14D in the timing controller can be resolved and, as a result, degradation in image quality of a display device can be prevented. However, in order to satisfy the inputting specifications of the LVDS transmission method, two external resistors are required and space for mounting the two external resistors must be provided on a signal processing board, thus inevitably increasing manufacturing costs.

By the technology disclosed in the Patent Reference 1, the method for resolving the unstable state of a signal occurring when the differential signal transmission path to be connected to the LVDS receiver is released. However, other problems associated with the conventional LVDS transmission method described above are not yet solved.

The standby means disclosed in the Patent Reference merits attention in relation to the present invention, however, enough technological information to solve the problems described above is not yet provided.

### SUMMARY OF THE INVENTION

In view of the above, it is an object of the present invention to provide an interface idle terminal processing method for avoiding an unstable state of an output from an electronic device on a receiver side even when a specified differential signal transmission path out of a plurality of differential signal transmission paths is not used and an interface using the idle terminal processing method.

According to a first aspect of the present invention, there is provided an interface idle terminal processing method for using a receiving terminal of at least one of differential signal transmission paths to be connected to a specified receiver-side differential amplifying circuit as an idle terminal to perform interfacing between a plurality of transmitter-side differential amplifying circuits and a plurality of receiver-side differential amplifying circuits by connecting each of the differential signal transmission paths between each of the plurality of transmitter-side differential amplifiers and each of the plurality of receiver-side differential amplifiers, the interface idle terminal processing method including:

inputting a signal for idle terminal setting to at least one of the specified receiver-side differential amplifying circuit to be used as the idle terminal; and

setting a voltage of the receiving terminal to be used as the idle terminal at a specified voltage within a normal operation range based on the signal for idle terminal setting.

In the foregoing first aspect, a preferable mode is one wherein the interfacing is performed between a first controller to be mounted in an electronic device and a second controller to be mounted in the electronic device and to be controlled by the first controller.

Also, a preferable mode is one wherein the first controller is a graphics controller of a display device and the second controller is a timing controller of the display device.

Also, a preferable mode is one wherein the signal for idle terminal setting is one signal and, based on the one signal, a signal for idle terminal setting for at least one of signal transmission paths making up the differential signal transmission paths is produced.

Also, a preferable mode is one wherein the signal for idle terminal setting is the signal for idle terminal setting for each of signal transmission paths making up the differential signal transmission paths.

Also, a preferable mode is one wherein the voltage within the normal operation range is produced based on a non-inverted phase reference voltage and an inverted-phase reference voltage of each of the differential signal transmission paths.

Also, a preferable mode is one wherein the voltage within the normal operation range is produced by dividing a non-inverted phase reference voltage and an inverted-phase reference voltage using the resistance-type potential dividing circuit including a terminating resistor connected to each of the differential signal transmission paths in response to the signal for idle terminal setting for each of the signal transmission paths.

According to a second aspect of the present invention, there is provided an interface device having a plurality of differential signal transmission paths connected between each of a plurality of transmitter-side differential amplifying circuits and each of a plurality of receiver-side differential amplifying circuits, the interface device including:

an inputting unit to input a signal for idle terminal setting to at least one of the receiver-side differential amplifying circuits to be used as an idle terminal when a receiving terminal of at least one of the differential signal transmission paths to be connected to at least one of specified receiver-side differential amplifying circuits is used; and

a voltage setting unit to set a voltage of the receiving terminal to be used as the idle terminal at a specified voltage within a normal operation range based on the signal for idle terminal setting to be input by the inputting unit.

In the foregoing second aspect, a preferable mode is one wherein each of the differential signal transmission paths connects a first controller to be mounted in an electronic device to a second controller to be mounted in the electronic device and to be controlled by the first controller.

Also, a preferable mode is one wherein the first controller is a graphics controller of a display device and the second controller is a timing controller of the display device.

Also, a preferable mode is one wherein the inputting unit includes a generating unit to input one signal for idle terminal setting and to generate, based on the one signal for idle terminal setting, a signal for idle terminal setting for at least one of the signal transmission paths making up the differential signal transmission paths.

Also, a preferable mode is one wherein the inputting device is a unit to input the signal for idle terminal setting for at least one of the signal transmission paths making up the differential signal transmission paths.

Also, a preferable mode is one wherein the voltage setting unit produces the voltage within the normal operation range based on a non-inverted phase reference voltage and an inverted-phase reference voltage of each of the differential signal transmission paths.

Also, a preferable mode is one wherein the voltage setting unit produces a specified voltage within the normal operation range by dividing a non-inverted phase reference voltage and an inverted-phase reference voltage using a resistance-type potential dividing circuit including a terminating resistor connected to each of the differential signal transmission paths in response to the signal for idle terminal setting for each of the signal transmission paths.

Also, a preferable mode is one wherein the resistance-type potential dividing circuit includes a resistor connected serially between a power supply for a non-inverted phase reference voltage and one signal transmission path out of the differential signal transmission paths, a first transistor whose control electrode receives a signal for idle terminal setting from the one signal transmission path, a resistor connected serially between a power supply for an inverted-phase reference voltage and another signal transmission path out of the differential signal transmission paths, a second transistor whose control electrode receives a signal for idle terminal setting from the another signal transmission path and which is turned ON or OFF at the same time when the first transistor is turned ON or OFF, and the terminating resistor connected between one signal transmission path and another signal transmission path making up the differential signal transmission paths.

Also, a preferable mode is one wherein the one signal transmission path is one of the non-inverted phase signal transmission path or the inverted-phase signal transmission path making up the differential signal transmission paths and the another signal transmission path is another of the non-inverted phase signal transmission path or the inverted-phase signal transmission path making up the differential signal transmission paths.

Also, a preferable mode is one wherein the non-inverted phase reference voltage is higher by a specified value than a ground voltage and the inverted-phase reference voltage is the ground voltage.

Also, a preferable mode is one wherein the first transistor and the second transistor are a unipolar transistor.

Furthermore, a preferable mode is one wherein, if the first transistor is a PMOS (p-channel Metal Oxide Semiconductor) transistor, the second transistor is an NMOS (n-channel MOS) transistor and, if the first transistor is the NMOS transistor, the second transistor is the PMOS transistor.

With the above configurations, in the interface idle terminal processing method for using a receiving terminal of at least one of differential signal transmission paths to be connected to a specified receiver-side differential amplifying circuit as an idle terminal to perform interfacing between a plurality of transmitter-side differential amplifying circuits and a plurality of receiver-side differential amplifying circuits by connecting each of the differential signal transmission paths between each of the plurality of transmitter-side differential amplifiers and each of the plurality of receiver-side differential amplifiers, methods of insertion of the resistance-type potential divider into the differential signal transmission path and cancellation of the insertion are employed, irrespective of use or non-use of a specified differential signal transmission path out of a plurality of differential signal transmission paths, the differential signal transmission system is made to operate normally and no interference with displaying operations of a display device occurs and the need for mounting an external resistor on the outside of the timing controller is eliminated. As a result, space for mounting the external resistor required in a signal processing board on which the timing controller is mounted can be reduced and thus costs for manufacturing can be reduced accordingly.

### BRIEF DESCRIPTION OF THE DRAWINGS

The above and other objects, advantages, and features of the present invention will be more apparent from the following description taken in conjunction with the accompanying drawings in which:

FIG. 1 is a schematic diagram for showing electrical configurations of an interface device according to a first embodiment of the present invention;

FIG. 2 is a schematic diagram showing configurations of a timing controller according to the first embodiment of the present invention;

FIG. 3 is a schematic diagram showing an example of use of the timing controller according to the first embodiment of the present invention;

FIG. 4 is a schematic diagram explaining operations of the interface device when using a D channel according to the first embodiment of the present invention;

FIG. 5 is a schematic diagram showing electrical configurations of an interface device according to a second embodiment of the present invention;

FIG. 6 is a schematic diagram explaining operations of the interface device of FIG. 5;

FIG. 7 is a schematic diagram showing electrical configurations of an interface device according to a third embodiment of the present invention;

FIG. 8 is a schematic diagram explaining operations of the interface device of FIG. 7;

FIG. 9 is a schematic diagram showing a timing controller used in a conventional display device;

FIG. 10 is a table showing signal specifications of LVDS video signals used in the conventional display device;

FIG. 11 is a diagram showing waveforms used in the signal specifications of the LVDS video signals used in the conventional display device;

FIG. 12 is a schematic circuit diagram for performing interface idle terminal processing on a D channel between a graphics controller and a timing controller in the conventional display device; and

FIG. 13 is a diagram showing connection by each channel between the graphics controller and the timing controller in the conventional display device.

### DETAILED DESCRIPTION OF THE PREFERRED EMBODIMENTS

Best modes of carrying out the present invention will be described in further detail using various embodiments with reference to the accompanying drawings. In an interface idle terminal processing method of the present invention for using a receiving terminal of at least one of differential signal transmission paths to be connected to a specified receiver-side differential amplifying circuit as an idle terminal to perform interfacing between a plurality of transmitter-side differential amplifying circuits and a plurality of receiver-side differential amplifying circuits by connecting each of the differential signal transmission paths between each of the plurality of transmitter-side differential amplifiers and each of the plurality of receiver-side differential amplifiers, a resistance-type potential divider is inserted into an unused differential signal transmission path and the insertion of the resistance-type potential divider is canceled when the differential signal transmission path is used.

### First Embodiment

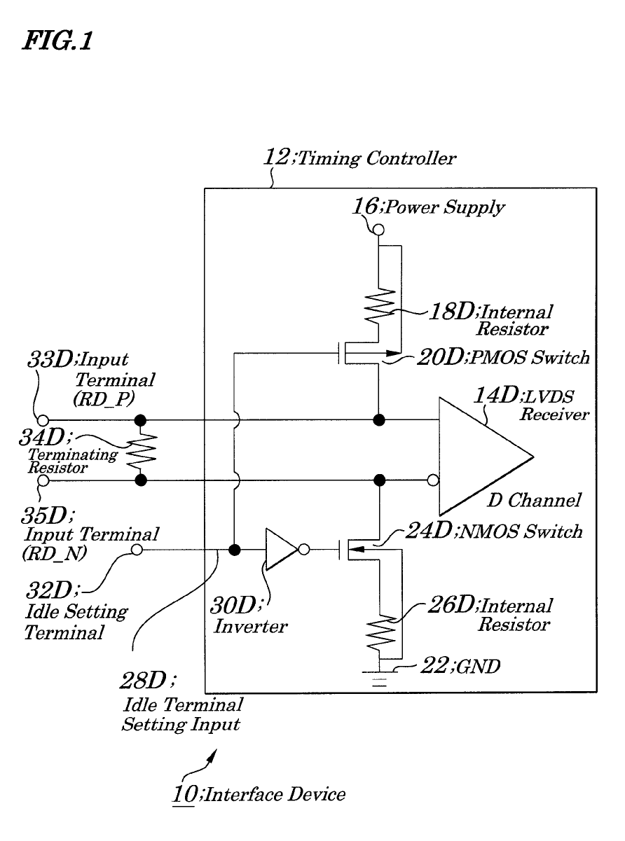

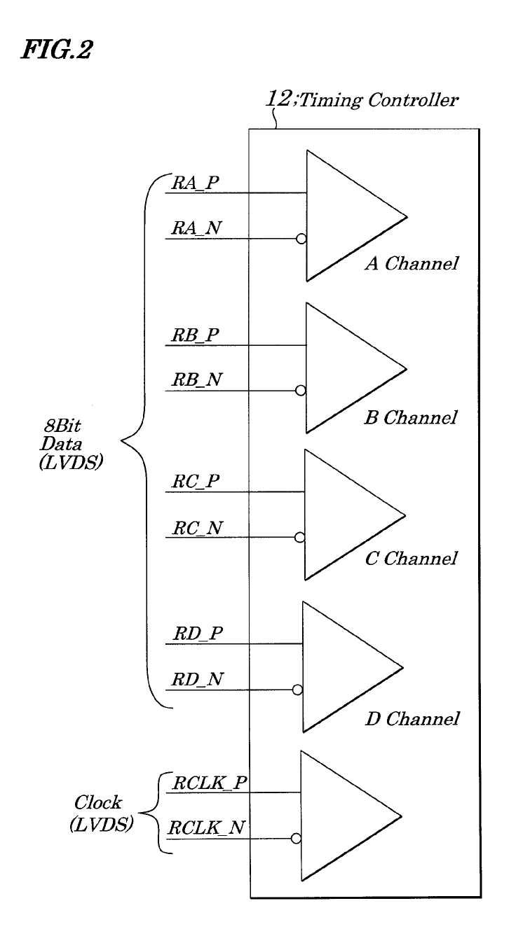

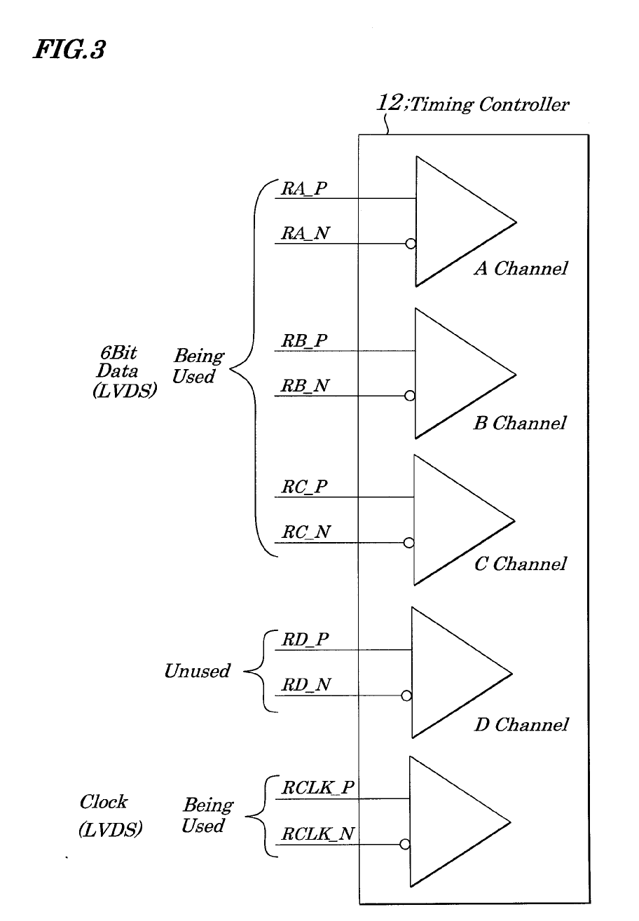

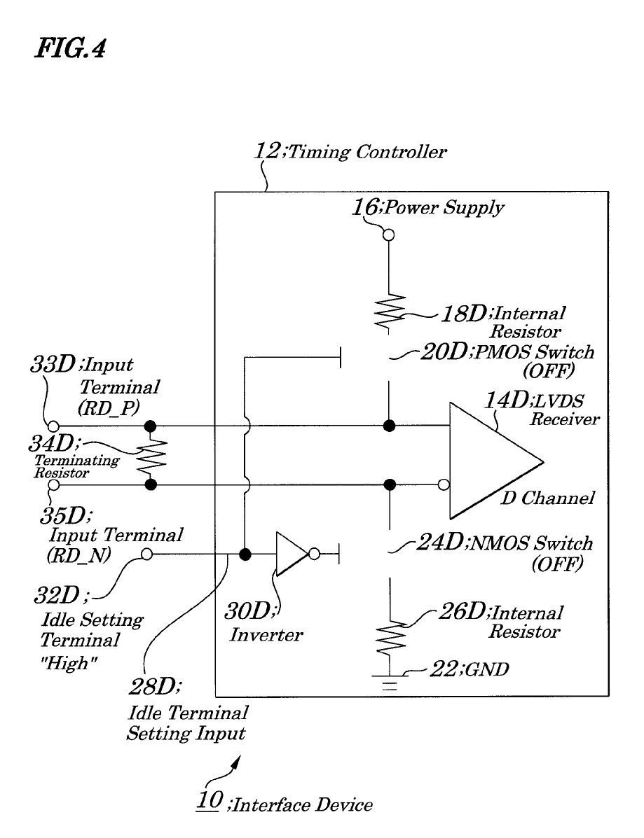

FIG. 1 is a schematic diagram showing electrical configurations of an interface device connected between a graphics controller and an LVDS receiver in a timing controller according to the first embodiment of the present invention. FIG. 2 is a schematic diagram showing configurations of the timing controller of the first embodiment. FIG. 3 is a schematic diagram showing an example of use of the timing controller according to the first embodiment. FIG. 4 is a schematic diagram explaining operations of an interface device when using a D channel of the first embodiment.

In the interface device 10 of the embodiment which performs interfacing between the graphics controller and the timing controller mounted in a flat panel display device, when a specified differential signal channel out of a plurality of differential signal channels (each being called an “LVDS” signal channel serving as a differential signal transmission path) connected between the graphics controller and the timing controller is not used, conditions for inputting and operation of the unused channel in the timing controller are made to meet specifications of the entire interface device to ensure normal operations of the differential signal channel so that the same interfacing operations can be performed as in the case where the normal number of differential signal channels is being employed.

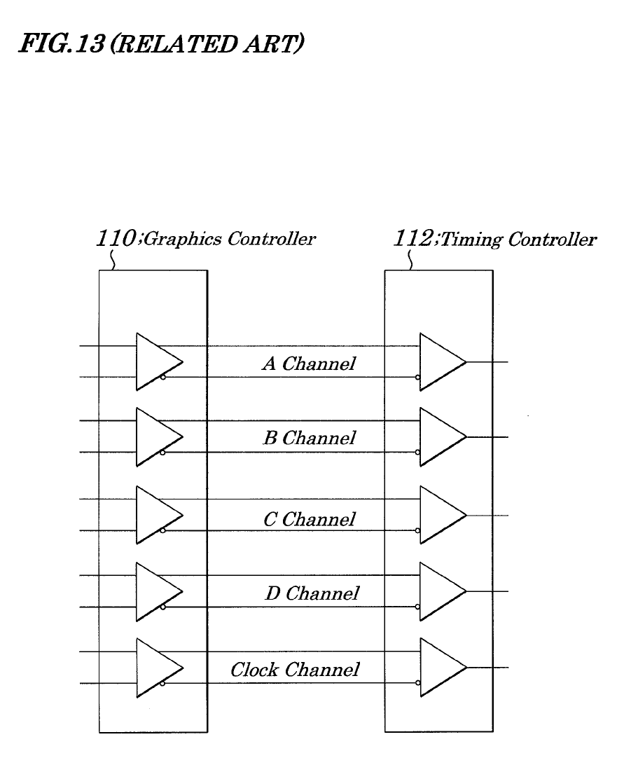

As shown in FIG. 1, the interface device 10 includes an internal resistor 18D serially connected between a non-inverted input terminal of an LVDS receiver 14D, for example, of the D channel employing an LVDS transmission method and being a differential signal channel that may be not used in some cases out of the differential signal channels mounted between the graphics controller 110 (not shown in FIG. 1, see FIG. 13) and a power supply (Vcc voltage), a PMOS switch 20D, an NMOS switch 24D and an internal resistor 26D both being serially connected between an inverted input terminal of the LVDS receiver 14D and a ground (GND) 22, an input terminal for setting an idle terminal 28D connected to a gate input terminal for the PMOS switch 20D and to an idle setting terminal 32D, an inverter 30D whose input terminal is connected to a terminal for the idle terminal setting input 28D and whose output terminal is connected to a gate input terminal for the NMOS switch 24D. The inverter 30D outputs a voltage of 0V when receiving an input of a Vcc voltage and outputs the Vcc voltage when receiving an input of 0V.

By using the interface device 10 shown in FIG. 1, as shown in FIG. 2, the timing controller 12 so configured as to process an LVDS video signal of 8 bits comes to process also an LVDS video signal of 6 bits. As shown in FIG. 1, in the interface device 10, an input terminal (RD_P) 33D is connected to a non-inverted terminal of the LVDS receiver 14D and an input terminal (RD_N) 35D is connected to an inverted input terminal. Between the input terminal (RD_P) and the input terminal (RD_N) 35D is connected a terminating resistor 34D. To the input terminal (RD_P) 33D is connected a non-inverted phase signal transmission path serving as a differential signal channel. To the input terminal (RD_N) 35D is connected an inverted-phase signal transmission path serving as a differential signal channel.

Next, operations of the interface device 10 of the embodiment are described by referring to FIGS. 1 to 4. In the interface device 10, when an LVDS video signal is received not in 8 bits but in 6 bits, that is, an LVDS video signal is received without using the D channel (FIG. 3), the idle setting terminal 32D is set to be “low”. This setting causes a voltage of 0V to be supplied to a gate input terminal of the PMOS switch 20D and a voltage of Vcc to be fed to its source and, therefore, a voltage between the gate and the source becomes −Vcc and the PMOS switch 20D is turned ON. As a result, the input terminal (RD_P) 33D of the LVDS signal channel is connected to the power supply 16 through the internal resistor 18D.

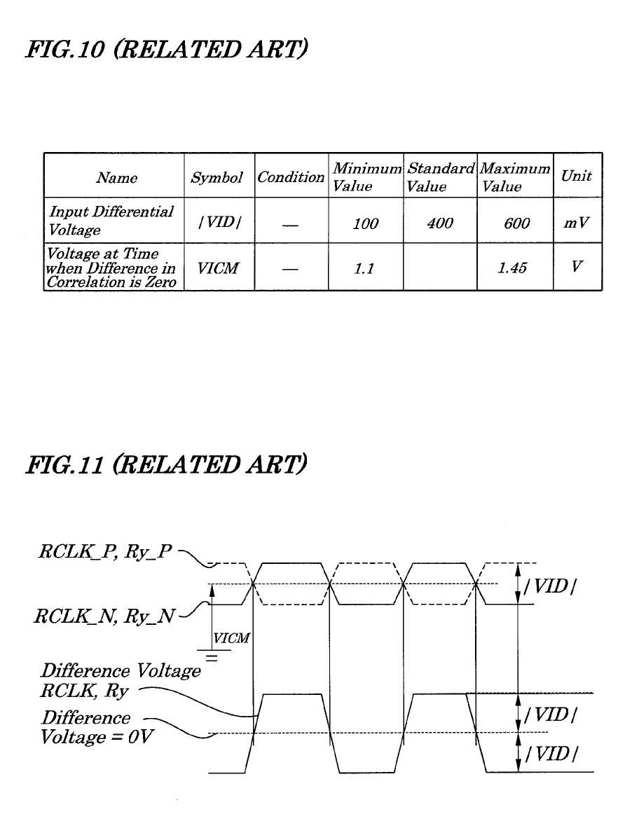

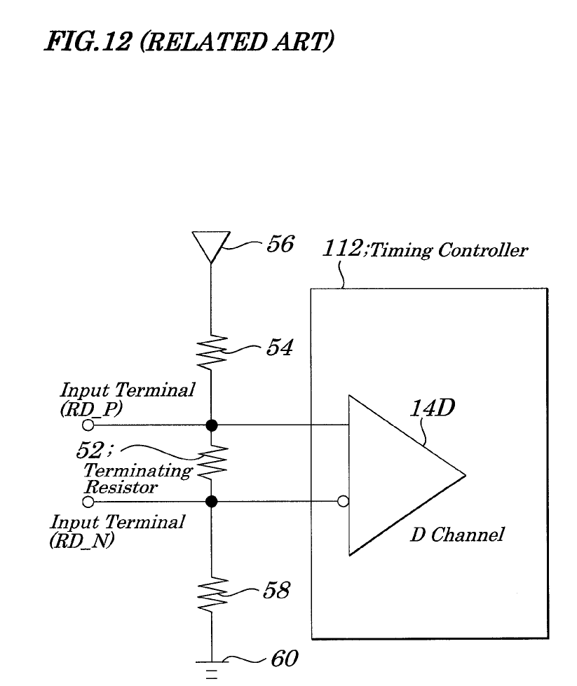

On the other hand, a voltage of Vcc is applied to a gate of the NMOS switch 24D through the inverter 30D and a ground voltage (GND) is applied to its source and, therefore, a voltage between the gate and the source becomes Vcc and the NMOS switch 24D is turned ON. As a result, the input terminal (RD_N) 35D of the VLDS signal channel is connected to the ground (GND) through the internal resistor 26D. For example, if Vcc is 3.3V, a resistance of the internal resistor 18D is 475 Ω, a resistance of the internal resistor 26D is 250Ω, and a resistance of the terminating resistor 34D is 100 Ω, since the voltage is divided by a resistance, a voltage of 1.4V is applied to the input terminal (RD_P) 33D and a voltage of 1.0V is applied to the input terminal (RD_N) 35D. These voltages applied to the input terminal (RD_P) 33D and input terminal (RD_N) 35D meet specifications of the LVDS inputting shown in FIGS. 10 and 11 and the output from the LVDS receiver 14D is clamped to be “high” and becomes stable and, as a result, no adverse effect on displaying operations by a display device occurs.

When a video signal to be transmitted through the LVDS signal channel is 8 bits long and the D channel is used, as shown in FIG. 4, the idle setting terminal 32D is set to be “high”. This setting causes a voltage of Vcc to be supplied to a gate input terminal of the PMOS switch 20D and a voltage Vcc to be fed to its source and, therefore, a voltage between the gate and the source becomes 0 V and the PMOS switch 20D is turned OFF. As a result, the input terminal (RD_P) 33D of the LVDS signal channel is disconnected from the internal resistor 18D.

On the other hand, a voltage of 0 V is applied to a gate of the NMOS switch 24D through the inverter 30D and a ground voltage (GND) is applied to its source and, therefore, a voltage between the gate and the source becomes 0 V and the NMOS switch 24D is turned OFF. As a result, the input terminal (RD_N) of the VLDS signal channel is disconnected from the internal resistor 26D. Therefore, when a video signal is input to the input terminal (RD_P) 33D and the input terminal (RD_N) 35D, the internal resistors 18D and 26D are not affected and the LVDS signal channel operates normally and, as a result, no adverse effect on displaying by a display device occurs.

Thus, according to the first embodiment, the idle terminal processing means is so configured that, if the D channel serving as one of the LVDS signal channels is not used, by insertion of a resistance-type potential divider, a voltage that can meet specifications of the LVDS inputting is applied as a non-inverted input and an inverted input to the LVDS receiver of the D channel and, if the D channel is used, a voltage of the LVDS video signal, as it is, is input by canceling of the insertion of the resistance-type potential divider and, therefore, irrespective of use or non-use of the D channel, the LVDS channel is made to operate normally and no interference with displaying operations of a display device occurs and the need for mounting an external resistor on the outside of the timing controller is eliminated. As a result, space for mounting the external resistor required in a signal processing board on which the timing controller is mounted can be reduced, thus achieving the reduction in costs for manufacturing accordingly.

### Second Embodiment

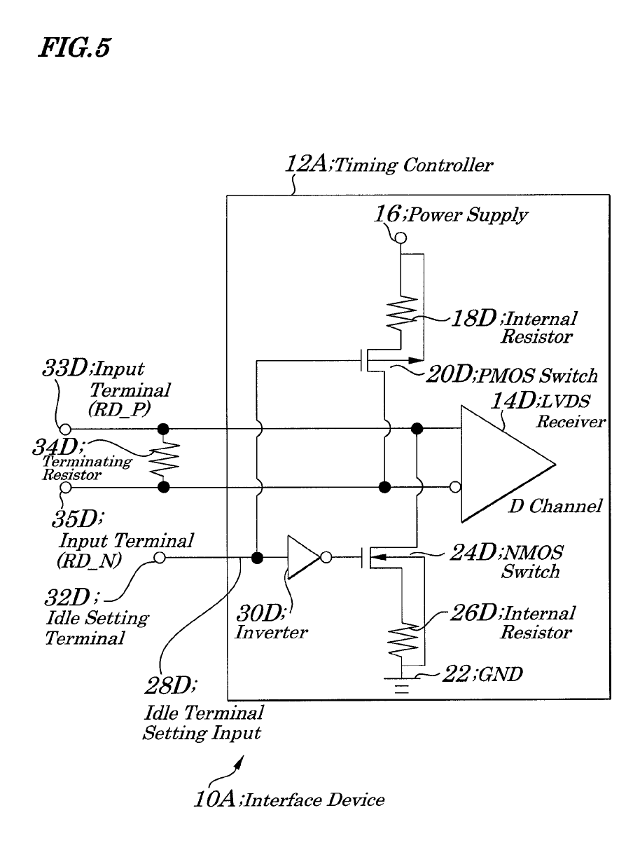

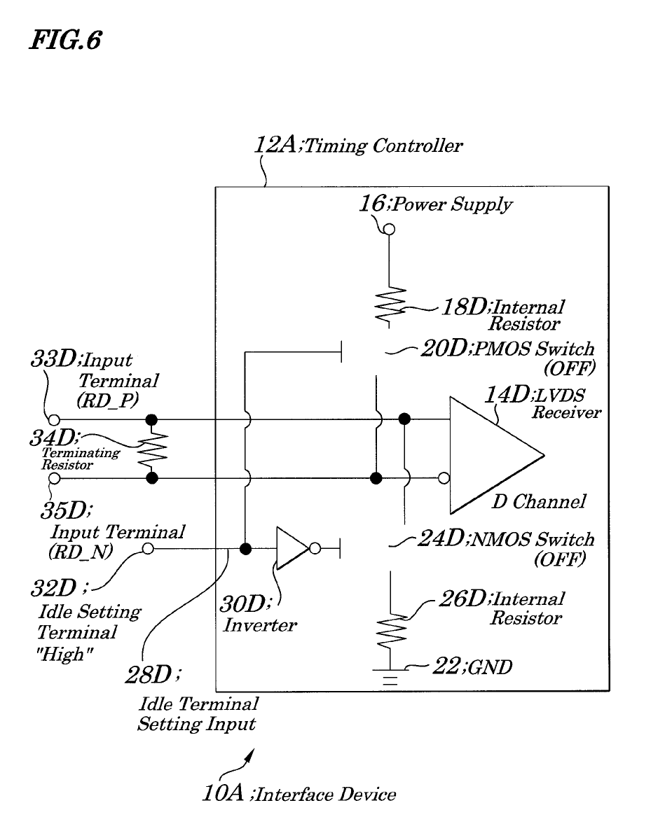

FIG. 5 is a schematic diagram showing electrical configurations of an interface device connected between a graphics controller and an LVDS receiver for a D channel in a timing controller according to the second embodiment. FIG. 6 is a schematic diagram explaining operations when the D channel is used in the interface device. Configurations of the interface device 10A of the second embodiment differ greatly from those in the first embodiment in that an output from a PMOS switch making up the interface device is used as an inverted input to the LVDS receiver 14D and an output from an NMOS switch is used as a non-inverted input to the LVDS receiver 14D as shown in FIG. 5. That is, in the interface device 10A of the second embodiment, a drain of the PMOS switch 20D is connected to an inverted input terminal of the LVDS receiver 14D and a drain of the NMOS switch 24D is connected to a non-inverted input terminal of the LVDS receiver 14D. Configurations other than described above are the same as those in the first embodiment and the same reference numbers are assigned to parts having the same functions as in the first embodiment and their descriptions are omitted accordingly.

Next, operations of the interface device 10A of the second embodiment are explained by referring to FIGS. 5 and 6. The operations of the interface device 10A in the second embodiment are the same as those in the first embodiment except the following differences. That is, the operations in the second embodiment are the same as in the first embodiment in that, in the interface device 10A, if an LVDS signal is received not in 8 bits but in 6 bits, in other words, if an LVDS signal is received without using the D channel (see FIG. 3), when the idle setting terminal 32D is set to be “low”, a voltage of 0V is applied to a terminal for a gate input to the PMOS switch 20D and a voltage between the gate and the source becomes −Vcc and the PMOS switch 20D is turned ON. However, in the second embodiment, an output from the PMOS switch 20D is fed to an inverted input terminal of the LVDS receiver 14D and, as a result, an input terminal (RD_N) 35D of the LVDS signal channel is connected to a power supply 16 through an internal resistor 18D.

On the other hand, the operations in the second embodiment are the same as in the first embodiment in that a voltage of Vcc is applied to a gate of the NMOS switch 24D through the inverter 30D and a voltage between the gate and source becomes Vcc and, as a result, the NMOS switch 24D is turned ON. However, in the second embodiment, an output from the NMOS switch 24D is used as a non-inverted input terminal of the LVDS receiver 14D and, therefore, the input terminal (RD_P) 33D of the LVDS signal channel is connected to a ground through the internal resistor 26D. For example, if Vcc is 3.3V, a resistance of the internal resistor 18D is 475 Ω, a resistance of the internal resistor 26D is 250 Ω, and a resistance of the terminating resistor 34D is 100 Ω, since the voltage is divided by a resistance, a voltage of 1.0 V is applied to the input terminal (RD_P) 33D and a voltage of 1.4 V is applied to the input terminal (RD_N) 35D. These voltages applied to the input terminal (RD_P) 33D and input terminal (RD_N) 35D meet specifications of the LVDS inputting shown in FIGS. 10 and 11 and the output from the LVDS receiver 14D is clamped to be “low” and becomes stable and, as a result, no adverse effect on displaying operations by a display device occurs.

When a video signal to be transmitted through the LVDS signal channel is 8 bits long and the D channel is used, as shown in FIG. 6, the idle setting terminal 32D is set to be “high”. This setting causes a voltage of Vcc to be supplied to a gate input terminal of the PMOS switch 20D and a voltage Vcc to be fed to its source and, therefore, a voltage between the gate and the source becomes 0 V and the PMOS switch 20D is turned OFF. As a result, the input terminal (RD_P) 33D of the LVDS signal channel is disconnected from the internal resistor 26D.

On the other hand, a voltage of 0V is applied to a gate of the NMOS switch 24D through the inverter 30 and a ground voltage (GND) is applied to its source and, therefore, a voltage between the gate and the source becomes 0 V and the NMOS switch 24D is turned OFF. As a result, the input terminal (RD_N) 35D of the VLDS signal channel is disconnected from the internal resistor 18D. Therefore, when a video signal is input to the input terminal (RD_P) 33D and the input terminal (RD_N) 35D, the internal resistors 18D and 26D are not affected and the LVDS signal channel operates normally and, as a result, no adverse effect on displaying of a display device occurs.

Thus, according to the second embodiment, the idle terminal processing means is so configured that, if the D channel serving as one of the LVDS signal channels is not used, by insertion of a resistance-type potential divider, a voltage that can meet specifications of the LVDS inputting is applied as a non-inverted input and an inverted input to the LVDS receiver for the D channel and, if the D channel is used, a voltage of the LVDS video signal, as it is, is input by canceling of the insertion of the resistance-type potential divider and, therefore, irrespective of use or non-use of the D channel, the LVDS channel is made to operate normally and no interference with displaying operations of a display device occurs and the need for mounting an external resistor on the outside of the timing controller is eliminated. As a result, space for mounting the external resistor required in a signal processing board on which the timing controller is mounted can be reduced. Thus, costs for manufacturing can be reduced accordingly.

### Third Embodiment

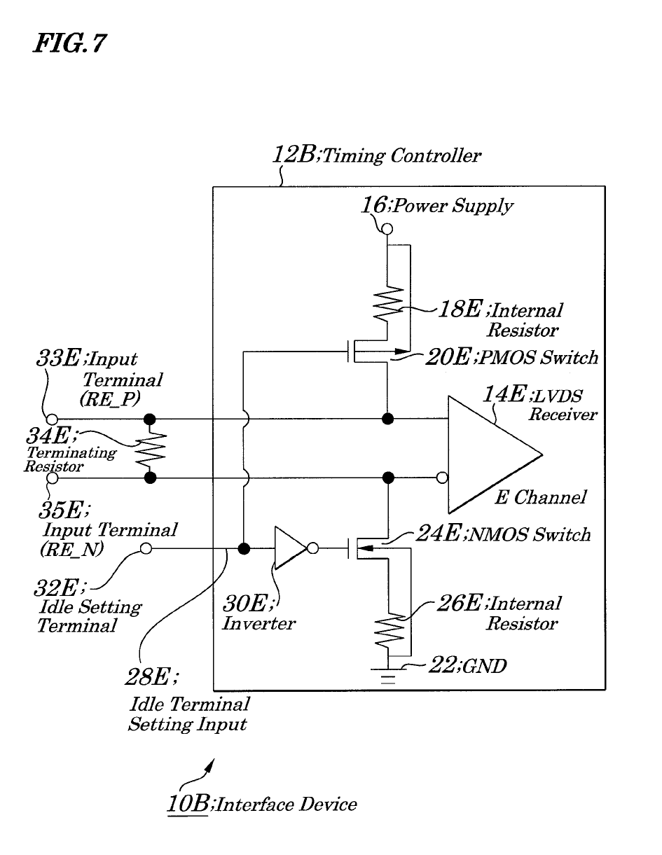

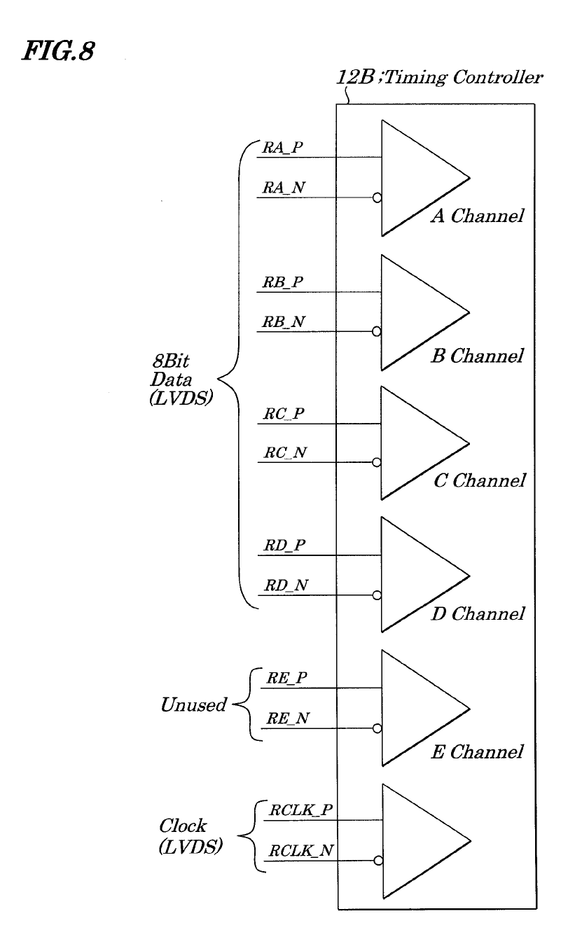

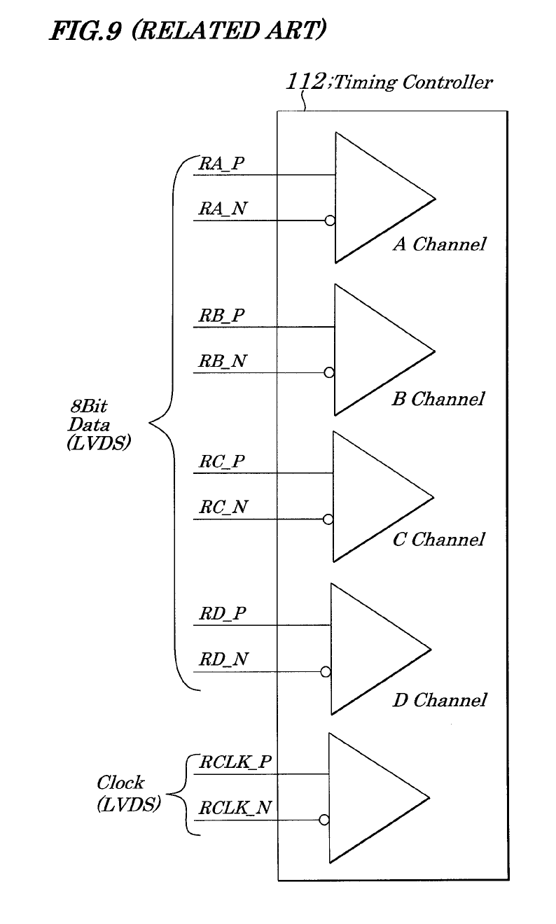

FIG. 7 is a schematic diagram showing electrical configurations of an interface device connected between a graphics controller and an LVDS receiver for a D channel in a timing controller according to the third embodiment. FIG. 8 is a schematic diagram explaining operations when the D channel is used in the interface device. Configurations of the interface device 10B of the second embodiment differ greatly from those in the first embodiment in that the timing controller 12B so configured as to receive an LVDS video signal of 10 bits comes to process an LVDS video signal of 8 bits.

That is, the interface device 10B of the third embodiment, as shown in FIG. 7 is configured by applying an invention philosophy employed in the first embodiment to an E channel mounted in a timing controller 12B configured so as to receive an LVDS video signal of 10 bits shown in FIG. 8. Therefore, configurations of the interface device 10B are the same as those in the first embodiment except the E channel on which idle terminal processing is to be performed and the same reference numbers are assigned to parts having the same functions as in the first embodiment and their descriptions are omitted accordingly. An alphabetical character “E” is used for each of the reference numbers instead of “D”. Moreover, the interface device 10B of the third embodiment may be configured by applying the invention philosophy employed in the first embodiment to the D channel to receive an LVDS video signal in the timing controller 12B and either of the D or E channel may be used selectively or both of the D and E channels may be used in combination.

Next, operations of the interface device 10B of the third embodiment are explained by referring to FIGS. 7 and 8. In the interface device 10B, an LVDS video signal is received not in 10 bits but in 8 bits, in other words, when an LVDS video signal is received without using the E channel (see FIG. 8), an idle setting terminal unit 32E is set to be “low”. This setting causes a voltage of 0V to be applied to a gate input terminal of the PMOS switch 20E and a voltage between the gate and the source of the PMOS switch 20E becomes −Vcc and the PMOS switch 20E is turned ON. As a result, the input terminal (RE_P) 33E of the LVDS signal channel is connected to the power supply 16 through the internal resistor 18E.

On the other hand, a voltage of Vcc is applied to a gate of the NMOS switch 24E through the inverter 30E and a voltage between the gate and the source of the NMOS switch 24E becomes Vcc and the NMOS switch 24E is turned ON. As a result, the input terminal (RE_N) 35E of the VLDS signal channel is connected to the ground (GND) through the internal resistor 26E. For example, if Vcc is 3.3V, a resistance of the internal resistor 18E is 475 Ω, a resistance of the internal resistor 26E is 250 Ω, and a resistance of the terminating resistor 34E is 100 Ω, since the voltage is divided by a resistance, a voltage of 1.4 V is applied to the input terminal (RE_P) 33E and a voltage of 1.0V is applied to the input terminal (RE_N) 35E. These voltages applied to the input terminal (RE_P) 33E and input terminal (RE_N) 35E meet specifications of the LVDS inputting shown in FIG. 10 and 11 and the output from the LVDS receiver 14E is clamped to be “high” and becomes stable and, as a result, no adverse effect on displaying operations by a display device occurs.

When a video signal to be transmitted through the LVDS signal channel is 10 bits long and the D channel is used, the idle setting terminal 32E is set to be “high”. This setting causes a voltage of Vcc to be supplied to a gate input terminal of the PMOS switch 20E and a voltage between the gate and the source of the PMOS switch 20E becomes 0 V and the PMOS switch 20E is turned ON. As a result, the input terminal (RE_P) 33E of the LVDS signal channel is disconnected from the internal resistor 18E.

On the other hand, a voltage of 0 V is applied to a gate of the NMOS switch 24E through the inverter 30E and a voltage between the gate and the source of the NMOS switch 24E becomes Vcc and the NMOS switch 24E is turned OFF. As a result, the input terminal (RE_N) 35E of the VLDS signal channel is disconnected from the internal resistor 26E. Therefore, when a video signal is input to the input terminal (RE_P) 33E and the input terminal (RE_N) 35E, the internal resistors 18E and 26E are not affected and the LVDS signal channel operates normally and, as a result, no adverse effect on displaying of a display device occurs.

Moreover, when the idle terminal processing is performed on the D channel, in the same way as employed in the first embodiment, the idle setting terminal 32E is set to be “low”. Operations to be performed in this case are the same as those in the first embodiment and their descriptions are omitted accordingly. When the idle terminal processing is not performed on the D channel, in the same way as employed in the first embodiment, the idle setting terminal 32E is set to be “high”. Operations to be performed in this case are the same as those in the first embodiment and their descriptions are omitted accordingly.

Thus, according to the third embodiment, the idle terminal processing means is so configured that, if the E channel out of the LVDS signal channels or both of the E and D channels are not used, by insertion of the resistance-type potential divider, a voltage that can meet specifications of the LVDS inputting is applied as a non-inverted input and an inverted input to the LVDS receiver for the E channel or both of the D and E channels and, if the E channel or both of the E and D channels are used, a voltage of the LVDS video signal, as it is, is input by canceling of the insertion of the resistance-type potential divider and, therefore, irrespective of use or non-use of the E channel or both of the E and D channels, the other LVDS channels are made to operate normally and no interference with displaying operations of a display device occurs and the need for mounting an external resistor on the outside of the timing controller is eliminated. As a result, space for mounting the external resistor required in a signal processing board on which the timing controller is mounted can be reduced. Thus, costs for manufacturing can be reduced accordingly.

It is apparent that the present invention is not limited to the above embodiments but may be changed and modified without departing from the scope and spirit of the invention. For example, in the third embodiment, the same invention philosophy as used in the second embodiment may be applied to the E channel or both of the E and D channels. Also, to apply the invention philosophy used in the first or second embodiment to the third embodiment, the idle setting terminal may be connected to all the channels so that setting for the idle terminal is selected. Moreover, even when a terminating resistor is not used for the LVDS video signal channel, the present invention can be carried out. As a result, space for mounting the external resistor required in the signal processing board on which the timing controller is mounted can be reduced, thus leading to reduction in costs for manufacturing. Also, the terminating resistor can be embedded in the timing controller described above. As the MOS switch used in the above embodiments, either of a PMOS or NMOS may be employed. Instead of the MOS switch, other unipolar transistor may be used. As the resistance-type potential divider, other equivalent circuits may be used.

Furthermore, the interface idle terminal processing method employed in the above interface device and the interface device can be applied to signal transmitting and receiving device other than display devices using a differential signal transmission path.

What is claimed is:

1. An interface idle terminal processing method for using a receiving terminal of at least one of differential signal transmission paths to be connected to a specified receiver-side differential amplifying circuit as an idle terminal to perform interfacing between a plurality of transmitter-side differential amplifying circuits and a plurality of receiver-side differential amplifying circuits by connecting each of said differential signal transmission paths between each of said plurality of transmitter-side differential amplifiers and each of said plurality of receiver-side differential amplifiers, said interface idle terminal processing method comprising:
inputting a signal for idle terminal setting to at least one of said specified receiver-side differential amplifying circuit to be used as said idle terminal; and
setting a voltage of said receiving terminal to be used as said idle terminal at a specified voltage within a normal operation range based on said signal for idle terminal setting.

2. The interface idle terminal processing method according to claim 1, wherein said interfacing is performed between a first controller to be mounted in an electronic device and a second controller to be mounted in said electronic device and to be controlled by said first controller.

3. The interface idle terminal processing method according to claim 2, wherein said first controller is a graphics controller of a display device and said second controller is a timing controller of said display device.

4. The interface idle terminal processing method according to claim 1, wherein said signal for idle terminal setting is one signal and, based on said one signal, a signal for idle terminal setting for at least one of signal transmission paths making up said differential signal transmission paths is produced.

5. The interface idle terminal processing method according to claim 1, wherein said signal for idle terminal setting is said signal for idle terminal setting for each of signal transmission paths making up said differential signal transmission paths.

6. The interface idle terminal processing method according to claim 1, wherein the voltage within the normal operation range is produced based on a non-inverted phase reference voltage and an inverted-phase reference voltage of each of said differential signal transmission paths.

7. The interface idle terminal processing method according to claim 6, wherein the voltage within the normal operation range is produced by dividing a non-inverted phase reference voltage and an inverted-phase reference voltage using the resistance-type potential dividing circuit including a terminating resistor connected to each of said differential signal transmission paths in response to said signal for idle terminal setting for each of said signal transmission paths.

8. An interface device having a plurality of differential signal transmission paths connected between each of a plurality of transmitter-side differential amplifying circuits and each of a plurality of receiver-side differential amplifying circuits, said interface device comprising:
an inputting unit to input a signal for idle terminal setting to at least one of said receiver-side differential amplifying circuits to be used as an idle terminal when a receiving terminal of at least one of said differential signal transmission paths to be connected to at least one of specified receiver-side differential amplifying circuits is used; and
a voltage setting unit to set a voltage of said receiving terminal to be used as said idle terminal at a specified voltage within a normal operation range based on said signal for idle terminal setting to be input by said inputting unit.

9. The interface device according to claim 8, wherein each of said differential signal transmission paths connects a first controller to be mounted in an electronic device to a second controller to be mounted in said electronic device and to be controlled by said first controller.

10. The interface device according to claim 9, wherein said first controller is a graphics controller of a display device and said second controller is a timing controller of said display device.

11. The interface device according to claim 1, wherein said inputting unit comprises a generating unit to input one signal for idle terminal setting and to generate, based on said one signal for idle terminal setting, a signal for idle terminal setting for at least one of said signal transmission paths making up said differential signal transmission paths.

12. The interface device according to claim 1, wherein said inputting device is a unit to input the signal for idle terminal setting for at least one of said signal transmission paths making up said differential signal transmission paths.

13. The interface device according to claim 8, wherein said voltage setting unit produces the voltage within the normal operation range based on a non-inverted phase reference voltage and an inverted-phase reference voltage of each of said differential signal transmission paths.

14. The interface device according to claim 13, wherein said voltage setting unit produces a specified voltage within the normal operation range by dividing a non-inverted phase reference voltage and an inverted-phase reference voltage using a resistance-type potential dividing circuit including a terminating resistor connected to each of said differential signal transmission paths in response to said signal for idle terminal setting for each of said signal transmission paths.

15. The interface device according to claim 14, wherein the resistance-type potential dividing circuit comprises a resistor connected serially between a power supply for a non-inverted phase reference voltage and one signal transmission path out of said differential signal transmission paths, a first transistor whose control electrode receives a signal for idle terminal setting from said one signal transmission path, a resistor connected serially between a power supply for an inverted-phase reference voltage and another signal transmission path out of said differential signal transmission paths, a second transistor whose control electrode receives a signal for idle terminal setting from the another signal transmission path and which is turned ON or OFF at the same time when said first transistor is turned ON or OFF, and the terminating resistor connected between one signal transmission path and another signal transmission path making up said differential signal transmission paths.

16. The interface device according to claim 15, wherein said one signal transmission path is one of the non-inverted phase signal transmission path or the inverted-phase signal transmission path making up said differential signal transmission paths and said another signal transmission path is another of the non-inverted phase signal transmission path or the inverted-phase signal transmission path making up said differential signal transmission paths.

17. The interface device according to claim 13, wherein said non-inverted phase reference voltage is higher by a specified value than a ground voltage and said inverted-phase reference voltage is said ground voltage.

18. The interface device according to claim 16, wherein the first transistor and the second transistor are a unipolar transistor.

19. The interface device according to claim 18, wherein, if said first transistor is a PMOS (p-channel Metal Oxide Semiconductor) transistor, the second transistor is an NMOS (n-channel MOS) transistor and, if said first transistor is the NMOS transistor, the second transistor is the PMOS transistor.

20. An interface device having a plurality of differential signal transmission paths connected between each of a plurality of transmitter-side differential amplifying circuits and each of a plurality of receiver-side differential amplifying circuits, said interface device comprising:
an inputting means to input a signal for idle terminal setting to at least one of said receiver-side differential amplifying circuits to be used as an idle terminal when a receiving terminal of at least one of said differential signal transmission paths to be connected to at least one of specified receiver-side differential amplifying circuits is used; and
a voltage setting means to set a voltage of said receiving terminal to be used as said idle terminal at a specified voltage within a normal operation range based on said signal for idle terminal setting to be input by said inputting means.
